(19) United States
(12) Patent Application Publication
(10) Pub. No.: US 2003/0069843 A1
(43) Pub. Date: Apr. 10, 2003

(54) Method of delivering money

(75) Inventor: Avril M. Kidd, Dundee (GB)

Correspondence Address: Michael Chan, NCR Corporation, 1700 South Patterson Blvd., Dayton, OH, 45479-0001, US

(73) Assignee: NCR Corporation

(21) Appl. No.: 10/236,731

(22) Filed: Sep. 6, 2002

(30) Foreign Application Priority Data
Oct. 10, 2001 (GB) 0124272.6

(51) Int. Cl. G06F 17/60

(52) U.S. Cl. 705/39

(57) ABSTRACT

A method of delivering money to a user is described. The method comprises the steps of: receiving an order from a remote customer for goods and/or services; receiving a request for money; receiving electronic payment for the order plus the money; authorizing payment for the order plus the money; and delivering the order and money to the remote customer. The method may also include the step of charging a fee in addition to the value of the money for providing the money.

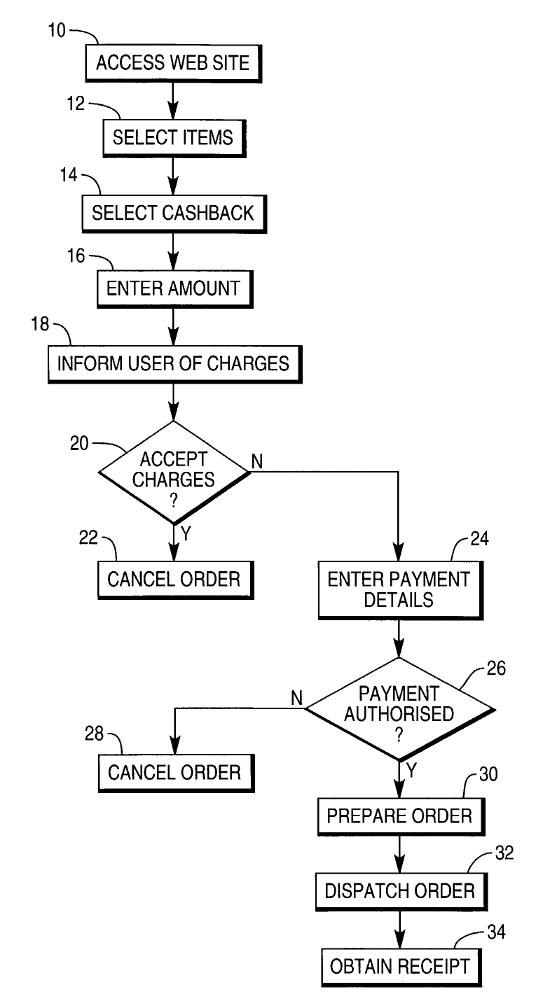

### BACKGROUND OF THE INVENTION

The present invention relates to a method of delivering money.

It is desirable for those people having an account with a financial institution to be able to access the money stored in the account in a reliable and convenient manner. At present, automated teller machines (ATMs) allow account holders to access funds reliably and conveniently. However, even ATMs have the disadvantage that users must leave the comfort and privacy of their homes to perform a transaction at an ATM.

If a user is not able to leave home to visit an ATM, for example, because the user is confined to his/her home as a result of a disability, then the user may have to entrust an ATM card to a friend to perform a transaction on his/her behalf. This involves a security risk because the user must also divulge the personal identity number (PIN) used to verify that the person presenting the card at an ATM is the legitimate cardholder.

Even if a user is able to leave home to visit an ATM, the user may not wish to do so because of weather conditions, social engagements, family commitments, the time taken to visit the ATM, and such like reasons.

### SUMMARY OF THE INVENTION

It is among the objects of an embodiment of the present invention to provide a more convenient method of receiving money.

According to a first aspect of the present invention there is provided a method of delivering money, the method comprising the steps of: receiving an order from a remote customer for goods and/or services; receiving a request for money; receiving electronic payment for the order and the money; authorizing payment for the order and the money; and delivering the order and money to the remote customer.

By virtue of this aspect of the invention, a remote customer is able to obtain money with an order for goods and/or services in a similar way to obtaining cashback at a supermarket.

The phrase “ordering a service” as used herein refers to the user requesting a person to come to the user to perform some service, for example, car valeting.

The step of authorizing payment may involve submitting a credit card payment or debit card payment to a transaction authorization system.

The method may include the step of charging a fee for the money delivered. The fee may be added to the cost of the order and the value of the money delivered.

The step of delivering the order and money to the remote customer may involve only delivering the order and money to an address associated with a card used to pay for the order and money. Alternatively, the step of delivering the order and money to the remote customer may involve the step of only delivering the order and money to an address that has previously been registered as associated with the user.

This has the advantage that a user can obtain money by having a supplier deliver money with goods or services, thereby avoiding the user having to leave his or her home or office to obtain money.

According to a second aspect of the present invention there is provided a method of delivering money, comprising the steps of: receiving a request from a remote customer for money; receiving electronic payment for the money and a surcharge; authorizing payment for the requested money; and delivering the requested money to the remote customer.

### BRIEF DESCRIPTION OF THE DRAWINGS

An embodiment of the present invention will now be described, by way of example, with reference to the accompanying diagram, which is a flowchart illustrating the steps involved in delivering money to a user's home.

### DETAILED DESCRIPTION

Referring to the diagram, a user decides to order groceries from a supermarket with which the user has previously registered for home delivery.

The user accesses a World Wide Web site (referred to hereinafter as a Web site) operated by the supermarket to allow users to select goods for delivery to the user's home (step 10). The Web site provides a sequence of Web pages that allow a user to select different grocery items and payment options.

The user then selects those grocery items that the user requires (step 12), and also selects an option for cashback (step 14) on a Web page, and indicates the amount of cash requested (step 16), in this example, thirty pounds sterling.

The Web site informs the user (step 18) that there is a five pounds charge for home delivery of the selected groceries and an additional one pound charge for delivering thirty pounds with the groceries, and prompts the user to accept or reject the charge (step 20).

If the user does not accept these charges (step 22), then the order is cancelled.

If the user accepts these charges, then the user provides details of the payment mechanism used (step 24). In this embodiment a credit card is used, so the user enters the card details (card number, expiry date, and such like) at the Web site.

The supermarket automatically attempts to authorize payment (step 26) for an amount equaling the cost of the groceries, plus the amount of money requested, plus the fee for home delivery, plus the fee for the money requested.

If the payment is not authorized then the user is informed that no delivery will take place because the payment was not authorized, and the order is cancelled (step 28).

If the payment is authorized, then the grocery order is prepared (step 30) and dispatched (step 32) to the user's registered address, together with the money ordered, in this example, thirty pounds.

When the user receives delivery of the groceries and money, then the user signs a receipt acknowledging delivery (step 34).

It will now be appreciated that this embodiment of the invention has the advantage that the user is able to access money without leaving the comfort of his/her home, and without having to divulge a PIN to a friend.

Various modifications may be made to the above described embodiment within the scope of the invention, for example, in other embodiments a different retail outlet may be used, such as a garden center, a furniture outlet, a plant (machinery) hire center, or such like. In some embodiments, the user may only order money, not any goods or services. In some embodiments, no fee may be charged for delivering money, only for delivering goods and/or services. In other embodiments, the user may order goods and/or services and money by telephone rather than using the Internet.

What is claimed is:

1. A method of delivering money, the method comprising the steps of:
receiving an order from a remote customer for goods and/or services;
receiving a request for money;
receiving electronic payment for the order and the money;
authorizing payment for the order and the money; and
delivering the order and money to the remote customer.

2. A method according to claim 1, wherein the step of authorizing payment includes submitting a credit card payment or debit card payment to a transaction authorization system.

3. A method according to claim 1, further comprising the step of charging a fee for the money delivered.

4. A method according to claim 2, wherein the step of delivering the order and money to the remote customer includes only delivering the order and money to an address associated with a card used to pay for the order and money.

5. A method according to claim 1, wherein the step of delivering the order and money to the remote customer is performed by only delivering the order and money to an address that has previously been registered.

6. A method of delivering money, the method comprising the steps of:
receiving a request from a remote customer for money;
receiving electronic payment for the money plus a surcharge;
authorizing payment for the requested money; and
delivering the requested money to the remote customer.

7. A method of conducting business with a customer located remotely from the business, the method comprising the steps of:
receiving from the customer an order for goods and/or services;
receiving from the customer a request for money;
receiving from the customer electronic payment for the order and the money; and
delivering the order and money to the customer when electronic payment for the order and the money is received from the customer.

8. A method according to claim 7, further comprising the step of charging the customer a fee for the money delivered.

9. A method of delivering money to a customer at the customer's home, the method comprising the steps of:
receiving from the customer an order for goods and/or services;
receiving from the customer a request for money;
receiving from the customer electronic payment for the order and the money; and
delivering the order and money to the customer at the customer's home when electronic payment for the order and the money is received from the customer.

10. A method according to claim 9, further comprising the step of charging the customer a fee for the money requested.

11. A method according to claim 9, further comprising the step of charging the customer a fee for home delivery.
